(19) United States
(12) Patent Application Publication
(10) Pub. No.: US 2005/0229750 A1
(43) Pub. Date: Oct. 20, 2005

(54) Jar opener

(76) Inventor: John H. Duke, Providence, RI (US)

Correspondence Address: John H. Duke, 11 Elton Street, Providence, RI, 02906, US

(21) Appl. No.: 11/111,256

(22) Filed: Apr. 20, 2005

Related U.S. Application Data
(60) Provisional application No. 60/563,691, filed on Apr. 20, 2004.

(51) Int. Cl. B67B 7/14

(52) U.S. Cl. 81/3.4

(57) ABSTRACT

A hand-held jar opener first stores rotational user energy in a clock spring while progressively closing a grip means to engage lids of different sizes. Next it grips the lid and provides mechanical advantage to the user to initially loosen it. Lastly it releases said stored rotational user energy to further unscrew the lid without additional user effort.

This application claims priority on Provisional Patent Application No. 60/563,691 filed Apr. 20, 2004

### FIELD OF INVENTION

This invention relates to hand held tools which provide mechanical advantage to a user in loosening twist type jar lids.

### BACKGROUND OF THE INVENTION

In the prior art, Battles in U.S. Pat No. 6,679,138 B2 describes a bottle opener containing one or more fixed cams, or alternately a rolling cylinder, which can engage a narrow range of bottle top diameters. Rhodes in U.S. Pat No. 4,643,053 describes a device for loosening oil filters containing spring loaded eccentric cams which similarly can only engages a narrow range of filter diameters.

In U.S. Pat. No. 1,593,947 Miller and Dirschauer describe a device for tightening a standard size fruit jar lid which contains rockable jaws and means to employ friction with the lid top to close said jaws. The rockable jaws are claimed with and without associated fulcrums at a fixed diameter from the device's center, but no alternative feature is described upon which said jaws may rock. This device can similarly only engages a narrow range of lid diameters

### OBJECTS AND ADVANTAGES

The principle object and advantage of the present invention is to provide a means to comfortably and intuitively loosen jar lids with a wide range of diameters. Presently available jar openers of the serrated V notch type are awkward to use because they require simultaneous application of radial and rotational force. Operation of the present invention is more like opening a jar unassisted, and is therefore more intuitive.

A second advantage of the present invention is that rotational energy stored in a clock spring is reused to further loosen the lid.

### BRIEF DESCRIPTION OF FIGURES

FIG. 1: Bottom perspective view while gripping lid of a jar;

FIG. 2: Bottom perspective view in open position;

FIG. 3: Top perspective view in open position;

FIG. 4: Exploded perspective view in open position;

FIG. 5: Bottom plan view in open position with dashed hidden lines and section line B-B;

FIG. 6: Section B-B view in open position;

FIG. 7: Bottom plan view while gripping lid of a jar with dashed hidden lines.

### DETAILED DESCRIPTION OF THE INVENTION

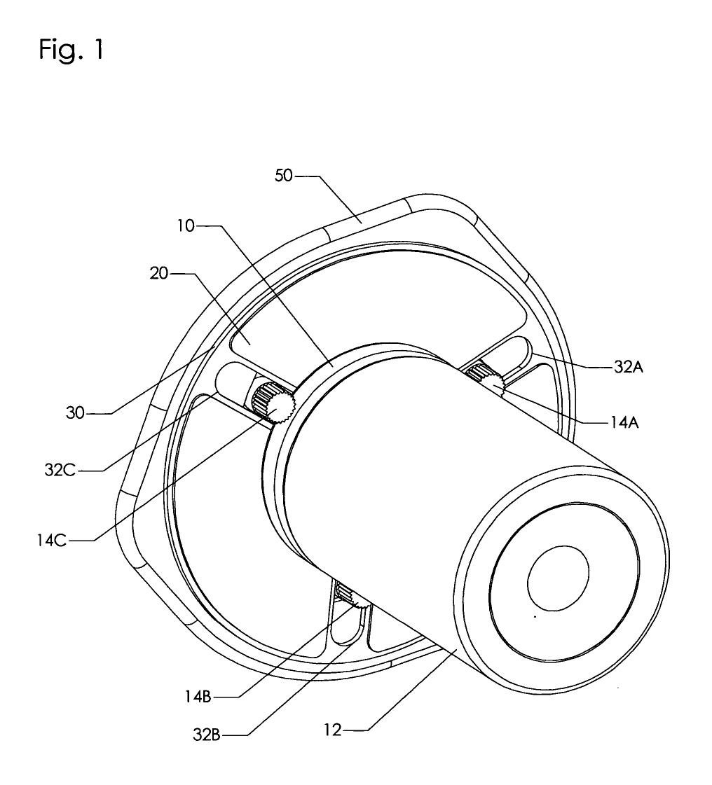

FIG. 1 is a perspective view showing the invention, as it may be held in a user's hand not shown, positioned to remove a conventional substantially round threaded lid 10 from a conventional jar 12. A group of grip posts 14A, 14B, and 14C bear against the circumferential surface of lid 10. The bottom surface of a friction pad 20 bears against the top surface of lid 10 due to a user supplied holding force. In the preferred embodiment friction pad 20 is made of a high friction elastomer such as Santoprene®. The upper surface of friction pad 20 is adhered to the bottom surface of a radial guide plate 30. Integral to radial guide plate 30 are a group of substantially radial slots 32A, 32B, and 32C around which friction pad 20 is trimmed. Grip posts 14A, 14B, and 14C extend respectively through radial slots 32A, 32B, and 32C. Said slots are sized so that said posts can slide along them with minimal clearance. Radial guide plate 30 rotatably connects to a spiral housing 50 as detailed below. Spiral housing 50 is non-round so that the user may efficiently apply torque thereto.

In the preferred embodiment the portion of the circumferential surfaces of grip posts 14A, 14B, and 14C which extend through radial plate slots 32A, 32B, and 32C are knurled to increase friction when bearing against lid 10. Alternative surface treatments may use an adhesive bonded abrasive material or a high friction elastomer.

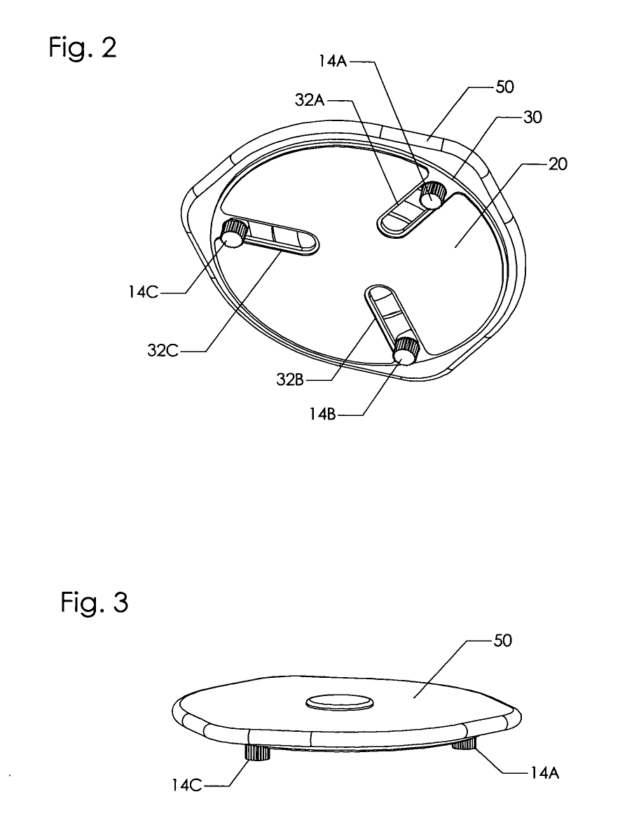

FIG. 2 and FIG. 3 are bottom and top perspective views showing the above components without jar 12 and lid 10.

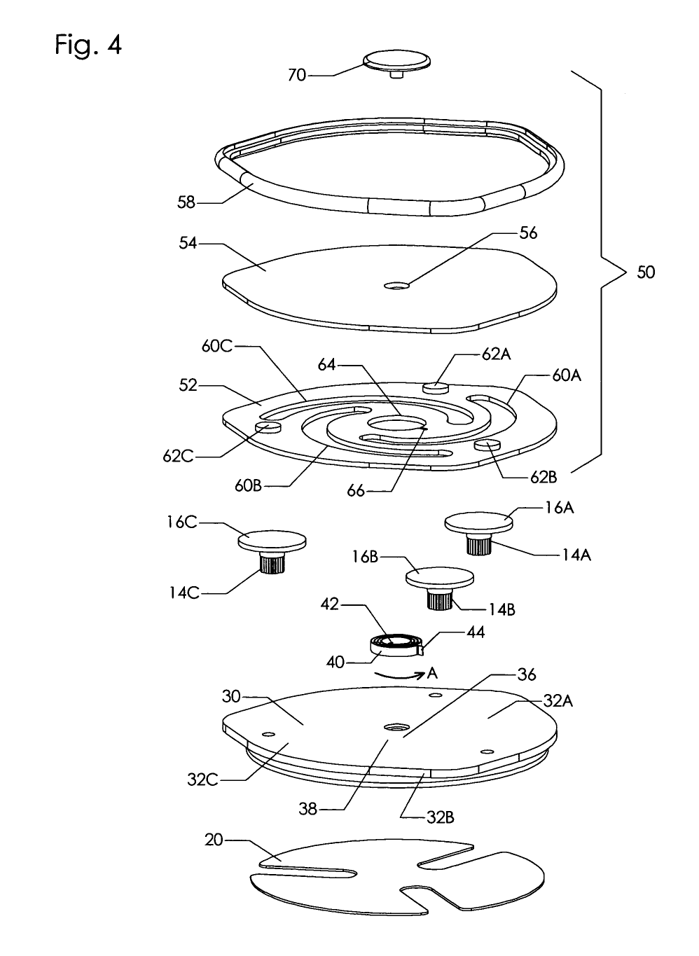

FIG. 4 is an exploded view further showing a hub 36 integral to and projecting from the top of radial guide plate 30. Hub 36 has a radial notch 38 in its circumferential surface. When unexploded a conventional clock spring 40 rests upon the top surface of radial guide plate 30. Spring 40 is wound in the direction indicated by an arrow A. An inner spring end 42 of spring 40 engages radial notch 38. Spring 40 is sized so that the rotational force required to wind it as installed is less than the rotational friction force between friction pad 20 and lid 10 resulting from typical user pressure against lid 10.

Further referring to FIG. 4, integral respectively to the top ends of grip posts 14A, 14B, and 14C are disc portions 16A, 16B, and 16C.

Further referring to FIG. 4, spiral housing 50 is comprised of a spiral guide plate 52, a top plate 54, an edge guard 58, and an end cap 70. An interior hole 56 in top plate 54 is slightly larger in diameter than hub 36. Spiral guide plate 52 has a group of spiral slots 60A, 60B, and 60C which are sized so that grip posts 14A, 14B, and 14C can slide along them with minimal clearance. Spiral guide plate 52 further incorporates a group of raised portions 62A, 62B, and 62C which project slightly higher than the thickness of disc portions 16A, 16B, and 16C. Spiral guide plate 52 lastly incorporates a center hole 64 sized to contain the outer diameter of spring 40. Hole 64 has a radial notch 66 in its circumferential surface.

When spiral housing 50 is unexploded grip posts 14A, 14B, and 14C extend respectively through spiral slots 60A, 60B, and 60C and disc portions 16A, 16B, and 16C rest between top plate 54 and spiral guide plate 52. Raised portions 62A, 62B, and 62C attach to top plate 54 with conventional fasteners not shown. The orientation of spiral slots 60A, 60B, and 60C is such that radial distances from the center of hole 56 to successive points on the outer surfaces of spiral slots 60A, 60B, and 60C increase in direction A.

When unexploded the bottom surface of spiral guide plate 52 of spiral housing 50 rests upon the top surface of radial guide plate 30, and hub 36 projects into and freely rotates within hole 56. As noted above, grip posts 14A, 14B, and 14C project further respectively through radial slots 32A, 32B, and 32C. An outer spring end 44 of spring 40 engages radial notch 66.

Edge guard 58 is a flexible ring fitted to the outer edges of spiral guide plate 52 and top plate 54. In the preferred embodiment edge guard 58 is an efficiently gripped high friction compound such as Santoprene®.

Lastly, end cap 70 connects to hub 36 and vertically restrains top plate 54 of spiral housing 50.

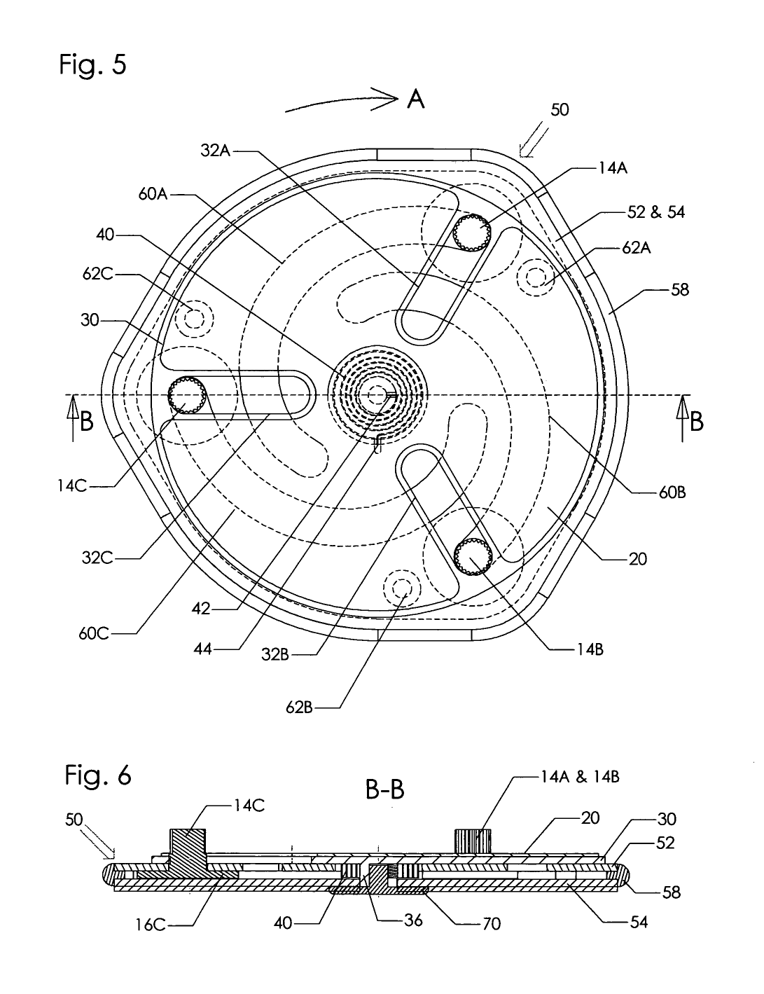

FIG. 5 shows a bottom plan view with dashed hidden lines. The orientation of spiral slots 60A, 60B, and 60C described above is such that when a user rotates spiral housing 50 with respect to radial guide plate 30 in the direction indicated by arrow A, the outer surfaces of said spiral slots push grip posts 14A, 14B, and 14C along radial slots 32A, 32B, and 32C towards hub 36. Turning spiral housing 50 in direction A also rotates outer spring end 44 in direction A thereby adding rotational energy to spring 40.

FIG. 6 is a section view corresponding to section line B-B of FIG. 5.

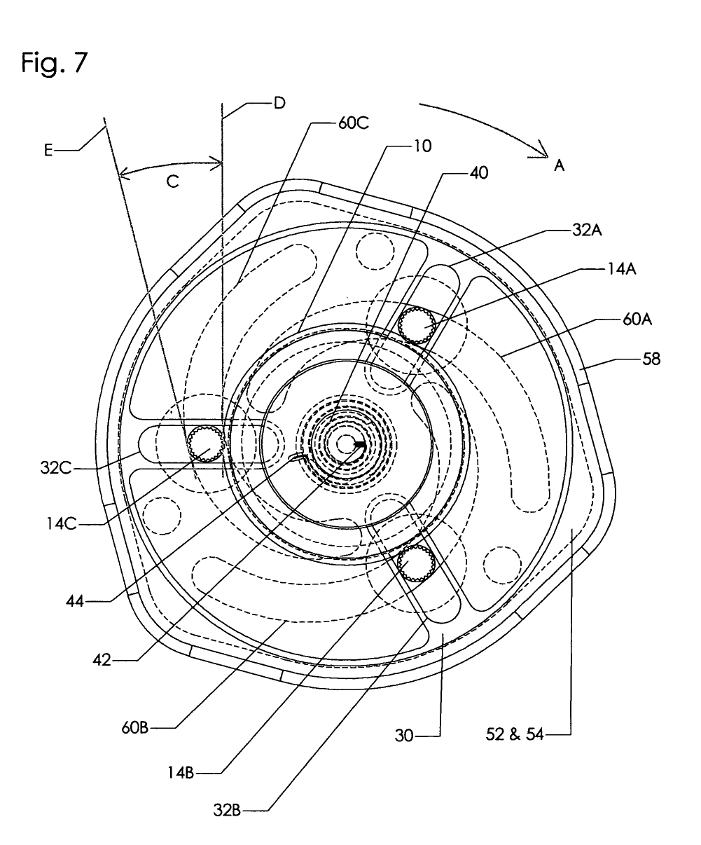

FIG. 7 is another bottom plan view which shows the invention gripping lid 10. Grip posts 14A, 14B, and 14C are at intermediate positions within radial slots 32A, 32B, and 32C. A ramp angle C is drawn between a line D tangent to the circumference of lid 10 at its point of contact with grip post 14C and a line E tangent to the outer surface of spiral slot 60C at its point of contact with grip post 14C. In the preferred embodiment angle C is approximately 14 degrees. The particular paths of spiral slots 60A, 60B, and 60C are loci of points at which analogous ramp angles are approximately constant for all allowed positions of spiral housing 50 with respect to radial guide plate 30.

Operation

Operation of the present invention entails three stages. A first pre-engagement stage entails turning spiral housing 50 in direction A with respect to jar 12 while friction pad 20 bears against the top of lid 10. As noted above, the rotational friction force resulting between friction pad 20 and lid 10 exceeds the force required to wind spring 40 as installed, so friction pad 20 and radial guide plate 30 do not rotate with respect to lid 10. As the user turns spiral housing 50, rotational energy is added to spring 40 and grip posts 14A, 14B, and 14C simultaneously converge until they contact the circumferential surface of lid 10. In thus converging said grip posts act to center lid 10 with respect to hub 36. In practice the user may simultaneously rotate jar 12 in the opposite direction if held in his or her another hand to sooner engage lid 10.

In a second loosening stage grip posts 14A, 14B, and 14C grip lid 10 by a means functionally analogous to that of a conventional roller clutch. A conventional roller clutch contains an inner race in contact with a group of rollers each pressed against a ramp by a spring. The inner race, rollers, and ramps are here analogous to lid 10, grip posts 14A, 14B, and 14C, and the outer surfaces of spiral slots 60A, 60B, and 60C respectively. The force on said grip posts which is analogous that of said spring, however, is here applied by the user by turning spiral housing 50 with respect to jar 12. This user supplied rotational force is translated from jar 12 through lid 19 and friction pad 20 to radial guide plate 30, and acts on said grip posts through the surfaces of radial slots 32A, 32B, and 32C. The interaction of said grip posts and said spiral slots then converts and magnifies the user applied rotational force into a radial griping force on lid 10. When lid 10 is efficiently gripped in this way the user then loosens its bond to jar 12 by continuing to turn spiral housing 50.

In the task of opening ajar by hand the maximum torque applied to the lid is typically limited by the radial force applied by one's fingers in grasping it. The wrist can do the turning but it is the fingers that slip. The translation described above of a user supplied rotational force into a radial gripping force is therefore a principal advantage of the invention. No finger strength is required to grasp the lid. The overall size and shape of spiral housing 50 combine with the high friction properties of edge guard 58 to provide mechanical advantage to the user in applying the above rotational force.

In a final unscrewing stage lid 10 is loose and the torque required to turn lid 10 diminishes. The user supplied rotational energy stored in spring 40 during said first pre-engagement stage now results in a torque on radial guide plate 30 in direction A with respect to spiral housing 50. As the user continues to turn spiral housing 50 in direction A spring 40 spontaneously unwinds when said torque required to turn lid 10 diminishes to less than said spring supplied torque on radial guide plate 30, less the torque required to overcome inertia and friction of said radial guide plate and said grip posts. With no additional user effort said unwinding of spring 40 then acts through friction pad 20 to further unscrew lid 10. As spring 40 unwinds it also acts to return grip posts 14A, 14B, and 14C to their original open positions, thus releasing lid 10 from said grip posts.

1. In a jar opener, the combination of
A user graspable housing incorporating three or more substantially similar, concentric and regularly arrayed spiral guide surfaces,
a set of rollable grip posts constrained within said housing so that one said post tangentially bears against each said spiral guide surface,
a radial guide disc rotatably mounted below said housing substantially concentric with said spiral guide surfaces which incorporates a set of substantially radial guide surfaces arrayed to tangentially bear against said grip posts,
a rotational spring interacting between said housing and said radial guide disc arranged to store energy when the user turns said housing in a first direction with respect to said radial guide disc,
and a friction pad mounted on the exposed surface of said radial guide disc in position to contact the top surface of a jar lid,
and further providing that said rollable grip posts project below the exposed face of said friction pad in position to contact the circumference of a jar lid,
and further providing that the spiral direction of said spiral guide surfaces is such that when the user turns said housing in said first direction with respect to said radial guide disc the combined action of said spiral guide surfaces and said radial guide surfaces propel said rollable grip posts towards the center of said radial guide disc.

2. The jar opener of claim 1 in which the shape of said spiral guide surfaces is such that for all points at which said rollable grip posts may contact the circumference of a jar lid, the acute angle between a first line tangent to said lid circumference at said lid contact point and a second line tangent to said spiral guide surface at the concurrent contact point of said rollable grip post and said spiral guide surface is less than twenty five degrees.
